(19) United States
(12) Patent Application Publication
(10) Pub. No.: US 2026/0001814 A1
(43) Pub. Date: Jan. 1, 2026

(54) METHODS FOR PRODUCING BETA-SILICON CARBIDE FIBER

(71) Applicant: UCHICAGO ARGONNE, LLC, Chicago, IL (US)

(72) Inventors: Sumit Bhattacharya, Darien, IL (US); Abdellatif M. Yacout, Naperville, IL (US)

(21) Appl. No.: 19/086,953

(22) Filed: Mar. 21, 2025

Related U.S. Application Data
(60) Provisional application No. 63/665,924, filed on Jun. 28, 2024.

(51) Int. Cl. C04B 35/622

(52) U.S. Cl. CPC C04B 35/62281; C04B 2235/428; C04B 2235/5244; C04B 2235/5248; C04B 2235/5264; C04B 2235/5445; C04B 2235/616; C04B 2235/6567

(57) ABSTRACT

Provided herein are methods of preparing beta silicon carbide (β-SiC) fiber, comprising: immersing a carbon fiber in a molten silicon bath at a temperature of up to 1650° C. and a pressure of 0.9 to 1.1 atm in an inert atmosphere and retaining the carbon fiber in the molten silicon bath for a hold time to react the carbon fiber with silicon present in the molten silicon bath and produce β-SiC fiber. Also provided herein are methods of preparing β-SiC fiber, comprising: immersing a carbon fiber in silicon powder at a temperature of 650° C. to 800° C. to thereby coat the carbon fiber with the silicon powder, and transferring the coated carbon fiber to a heating zone and heating the silicon powder coated carbon fiber to a temperature of 1400° C. up to 1650° C. to react the carbon fiber and the silicon powder to form β-SiC fiber.

### CROSS-REFERENCE TO RELATED APPLICATION

The benefit of priority to U.S. Provisional Patent Application No. 63/665,924 filed Jun. 28, 2024, is hereby claimed and the disclosure is incorporated herein by reference in its entirety.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates generally to methods of making beta silicon carbide fibers. More particularly, the disclosure relates to methods of producing beta silicon carbide fibers from carbon fibers immersed in molten Si.

### BACKGROUND

Silicon carbide (SiC) is the only chemical compound of carbon and silicon. SiC can be processed to produce SiC fibers, which have desirable properties relative to organic ceramic fibers such as high stiffness and high tensile strength. However, SiC can adopt numerous polymorphs which influence the properties of SiC fibers. The most readily found SiC form is alpha silicon carbide (α-SiC) phase, while beta silicon carbide (β-SiC) is more challenging to produce.

β-SiC fiber-based components are rapidly gaining traction in aerospace, energy, zero emission power plants (both nuclear/non-nuclear) and other high temperature industries due to its light weight, low neutron absorption, excellent high temperature behavior. This performance is especially important in nuclear applications, as β-SiC fiber exhibits favorable performance under irradiation. This makes it an ideal base material to build intricate composite structures with secondary materials (ceramic/metal) used as a matrix for harsh environments.

Current methods of producing β-SiC fiber include complicated polymer-derived continuous processes adopted from polycarbosilane (PCS) using silica, or chemical vapor deposition (CVD). These methods include multiple steps requiring temperatures greater than 1650° C., harsh reactants, and do not control the phase of SiC formed in the fiber. As a result of the numerous and intensive conditions required, the β-SiC fiber produced is prohibitively expensive.

### SUMMARY

Methods in accordance with the disclosure can be used to prepare beta silicon carbide (β-SiC) fiber from carbon fiber and elemental silicon. The β-SiC fiber prepared by methods of the disclosure can advantageously provide a lower cost manufacturing method for β-SiC fiber, thereby expanding the potential use of such fibers in various fields such as energy, aerospace, and other commercial applications, where long-term operation under extreme conditions (radiation) is needed.

A method of preparing beta silicon carbide (β-SiC) in accordance with the disclosure can include: immersing a carbon fiber in a molten silicon bath at a temperature of up to 1650° C. and a pressure of 0.9 to 1.1 atm in an inert atmosphere and retaining the carbon fiber in the molten silicon bath for a hold time to react the carbon fiber with silicon present in the molten silicon bath and produce β-SiC fiber. Immersing and retaining the carbon fiber in the molten silicon bath can include drawing the carbon fiber through the molten silicon bath at a draw rate that results in each immersed portion of the carbon fiber is retained in the molten silicon bath for the hold time.

A method of preparing beta silicon carbide (β-SiC) in accordance with the disclosure can include: immersing a carbon fiber in silicon powder at a temperature of 650° C. to 800° C. thereby coating the carbon fiber with the silicon powder; and transferring the coated carbon fiber to a heating zone and heating the silicon powder coated carbon fiber to a temperature of 1400° C. up to 1650° C. to react the carbon fiber with the silicon powder to form a β-SiC fiber.

### BRIEF DESCRIPTION OF THE DRAWINGS

FIG. 1 is a general scheme showing the formation of silicon carbide fiber with a method in accordance with the disclosure.

FIG. 2 is a general scheme of continuous formation of silicon carbide fiber with a method in accordance with the disclosure.

FIG. 3 is an image of an apparatus for performing a method in accordance with the disclosure using a molten silicon bath.

FIG. 4 is an image of carbon fiber coated in silicon powder, made by a method in accordance with the disclosure.

FIG. 5 is an image of an apparatus for performing a method in accordance with the disclosure using silicon powder.

FIG. 6A is an EDS-SEM image of silicon carbide fiber made by a method in accordance with the disclosure after 6 hours of immersion in molten silicon.

FIG. 6B is an image of an EDS line scan of silicon carbide fiber made by a method in accordance with the disclosure after 6 hours of immersion in molten silicon.

FIG. 6C is an EDS-SEM image of silicon carbide fiber made by a method in accordance with the disclosure after 24 hours of immersion in molten silicon.

FIG. 7A is a TEM image of silicon carbide fiber made by a method in accordance with the disclosure after 6 hours of immersion in molten silicon.

FIG. 7B is a TEM image of the boxed region of the silicon carbide fiber of FIG. 7A;

FIG. 7C is a TEM-SAED image of the Si-β-SiC phase interface at Region 1 of the silicon carbide fiber of FIG. 7B.

FIG. 7D is a TEM-SAED image of the unreacted carbon fiber phase at Region 3 of the silicon carbide fiber of FIG. 7B.

FIG. 7E is a TEM-SAED image of the developed SiC phase at Region 2 of the silicon carbide fiber of FIG. 7B.

FIG. 8A is a TEM image of silicon carbide fiber made by a method in accordance with the disclosure after 24 hours of immersion in molten silicon.

FIG. 8B is a TEM bright field image of a region of the silicon carbide fiber of FIG. 8A.

FIG. 8C is a TEM image of a region of the silicon carbide fiber of FIG. 8A, showing a zoomed in image of the boxed region.

FIG. 8D is a STEM image of a region of the silicon carbide fiber of FIG. 8A, showing a zoomed in image of the boxed region.

FIG. 8E is a TEM-SAED image of the circled region of the silicon carbide fiber shown in FIG. 8B.

FIG. 8F is a TEM image of the circled region of the silicon carbide fiber FIG. 8G.

FIG. 8G is a TEM-SAED image of the circled region of the silicon carbide fiber of FIG. 8C.

FIG. 8H is an EDS spectrum of silicon carbide fiber made by a method in accordance with the disclosure after 24 hours of immersion in molten silicon.

FIG. 9A is an image of the carbon fiber suspended above the molten silicon bath and wrapped in tantalum foil.

FIG. 9B is an image of the silicon carbide fiber made using carbon fiber suspended above the molten silicon bath and wrapped in tantalum foil.

FIG. 10 is a general scheme showing the formation of silicon carbide fiber as conventionally performed.

FIG. 11A is an EDS-SEM image of comparative silicon carbide fibers prepared from SiO₂.

FIG. 11B is an EDS-SEM image of a cross-section of a comparative silicon carbide fiber prepared from SiO₂.

FIG. 12A is an EDS-SEM image of a cross-section of a comparative silicon carbide fiber prepared from SiO₂ and Si powder.

FIG. 12B is an EDS image of a cross-section of a comparative silicon carbide fiber prepared from SiO₂ and Si powder.

FIG. 13 is an image of the atomic structure of the Siₘₑₗₜ/C_{graphite} interface before and after structural relaxations, using ab initio molecular dynamics (AIMD) simulations.

FIG. 14 is an image of the atomic structure of the Siₘₑₗₜ/Cₐₘₒᵣₚₕₒᵤₛ interface before and after structural relaxations, using AIMD simulations.

FIG. 15 is a FIB-SEM image of the adhesion of Siₘₑₗₜ on a crystalline carbon surface.

FIG. 16 is a FIB-SEM image of the adhesion of Siₘₑₗₜ on an amorphous carbon surface.

### DETAILED DESCRIPTION

Provided herein are methods for preparing beta silicon carbide (β-SiC) fiber from carbon fiber and elemental silicon. As used herein “beta silicon carbide (β-SiC) fiber” refers to a SiC fiber that is made of β-SiC as the primary phase of SiC present in the fiber. In some fibers of the disclosure, the β-SiC fiber is substantially all beta phase SiC. It is contemplated herein that the β-SiC fibers of the disclosure can include contents of other SiC phases, unreacted carbon, and impurities, such as oxygen, with beta-phase SiC as the primary component of the SiC fiber.

The methods of forming silicon carbide (β-SiC) fiber in accordance with the disclosure can include immersing a carbon fiber in a molten silicon bath at a temperature of up to 1650° C. and a pressure of 0.9 to 1.1 atm in an inert atmosphere and retaining the carbon fiber in the molten silicon bath for a hold time to react the carbon fiber with silicon present in the molten silicon bath. A schematic representation of a method of the disclosure is shown FIG. 1, where the carbon fiber is immersed and retained in the molten silicon bath (f), and during the hold time forms SiC (g), until the whole fiber is substantially SiC (h). Immersing and retaining the carbon fiber in the molten silicon bath can be achieved by drawing the carbon fiber through the molten silicon bath at a draw rate that results in each immersed portion of the carbon fiber to be retained in the molten silicon bath for the hold time. Alternatively, the carbon fiber or portions thereof can be immersed in the molten silicon bath and retain for the hold time without drawing. For example, an entirety of the carbon fiber can be immersed in the molten silicon bath. For example, portions of the carbon fiber can be immersed in the silicon bath for the hold time and then a subsequent portion of the carbon fiber can be immersed in the silicon bath for a subsequent hold time. This can be repeated until an entirety of the carbon fiber is immersed and held for the hold time in the molten silicon bath. In accordance with methods of the disclosure, the molten silicon bath can be formed by heating elemental silicon powder under an inert gas to a temperature of 1400° C. to 1650° C.

The methods of the disclosure can further comprise removing unreacted silicon from the β-SiC fiber after the hold time. In the methods of the disclosure, removing unreacted silicon from the β-SiC fiber can include drawing the carbon fiber through an opening in a graphite structure after the carbon fiber is drawn through the molten silicon bath to remove excess silicon.

The molten silicon bath can be formed by heating elemental silicon under an inert gas to a temperature above the melting temperature of the silicon. Once transitioned to the molten state, the molten silicon bath can be held at a temperature suitable to maintain the molten state. For example, the temperature can be up to 1650° C. The temperature of the molten silicon bath can be held constant. The molten bath can be held at a temperature of 1400° C. to 1650° C. For example, the temperature can be about 1400° C. to about 1650° C. For example, the temperature can be about 1450° C. to about 1650° C. For example, the temperature can be about 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, or 1650° C., or any values therebetween or any ranges defined by these values. The molten silicon bath can be held at a constant or substantially constant temperature during immersion and retention of the carbon fiber in the molten silicon bath.

The pressure during immersion and retention of the carbon fiber in the molten silicon bath can be 0.9 to 1.1 atm. For example, the pressure can be about 0.9 to about 1.1 atm. For example, the pressure can be about 0.9, 1, or 1.1 atm, or any values therebetween or any ranges defined by these values. The pressure can be held constant or substantially constant during immersion and retention of the carbon fiber in the molten silicon bath.

The carbon fiber can be immersed in the molten silicon bath under an inert atmosphere. The inert atmosphere can include any gas that is not oxygen and does not react with carbon, silicon, or silicon carbide at temperatures of 1400° C. to 1650° C. For example, the inert gas can include argon (Ar), helium (He), or a mixture of both. It has been found advantageous that the use of an inert gas can prevent the reaction of carbon with oxygen to form carbon monoxide. For example, methods in accordance with the disclosure can be free of production of CO emissions.

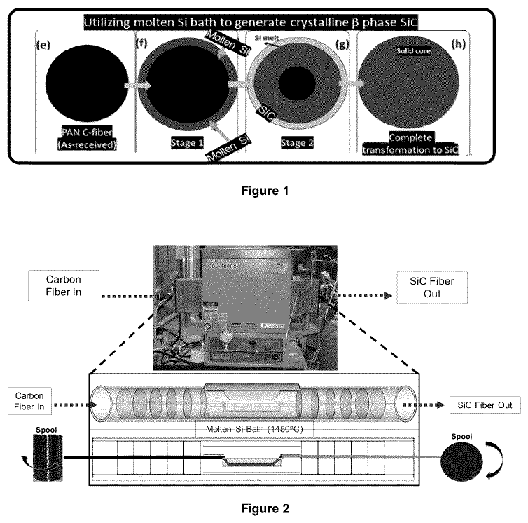

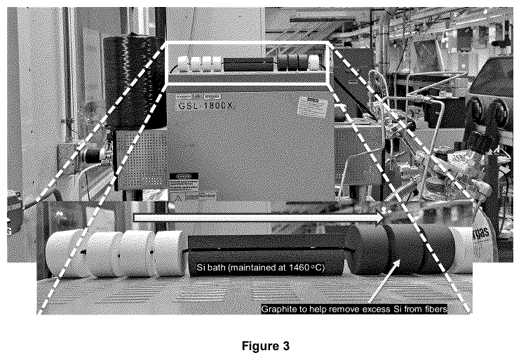

Referring to FIGS. 2 and 3, a drawing process can be used, for example, for immersing and retaining the carbon fiber in the molten silicon bath. After the fiber is immersed and retained in the molten silicon bath, the fiber is drawn through a graphite mold to remove excess Si. The rate at which the carbon fiber is drawn through the molten bath (referred to herein as a “draw rate”) can be selected such that results in each immersed portion of the carbon fiber is retained in the molten silicon bath for the hold time. Alternatively, the carbon fiber can be immersed and retained in an intermittent process as opposed to being drawn continuously through the molten silicon bath. For example, a portion of the carbon fiber can be immersed and retained in the molten silicon bath for the hold time and then that portion can be drawn out of the bath entirely, immersing a new portion of the carbon fiber in the molten silicon bath. This intermittent holding and drawing of portions of the silicon fiber can be repeated until an entirety of the carbon fiber (or desired portions thereof) are immersed and retained in the molten silicon bath for the hold time. As a still further alternative, an entirety of a length of the carbon fiber can be immersed in a molten silicon bath and retained for the hold time.

The hold time can be any time required for the carbon fiber to react completely with the silicon in the molten silicon bath. For example, the hold time can be about 12 hours to about 48 hours. For example, the hold time can be about 12, 14, 16, 18, 20, 22, 24, 26, 28, 30, 32, 34, 36, 38, 40, 42, 46, or 48 hours, or any values there between or ranges defined by such values.

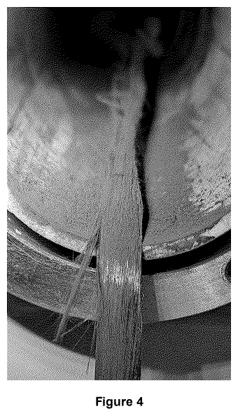

The methods of forming silicon carbide (β-SiC) fiber in accordance with the disclosure can also include immersing a carbon fiber in silicon powder at a temperature of 650° C. to 800° C. to thereby coat the carbon fiber with the silicon powder, and transferring the coated carbon fiber to a heating zone and heating the silicon powder coated carbon fiber to a temperature of 1400° C. up to 1650° C. to react the carbon fiber and the silicon powder to form β-SiC fiber. Referring to FIG. 4, immersing the carbon fiber in silicon powder at a temperature of 650° C. to 800° C. causes the carbon fiber to become coated in silicon powder, due to intermolecular forces between carbon and silicon, such as electrostatic forces.

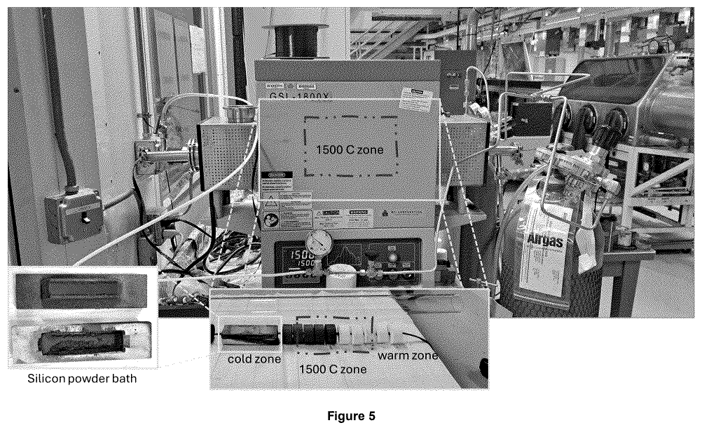

Referring to FIG. 5, a similar drawing process can be used with powdered silicon as that described above for the molten silicon bath. For example, the carbon fiber is immersed in the silicon powder a temperature of 650° C. to 800° C. (“cold zone”), which results in coating the carbon fiber in silicon powder. Then, the silicon powder coated carbon fiber is transferred into a zone at a temperature of 1400° C. to 1650° C. (1500 C zone”), where the carbon fiber and the silicon powder react to form β-SiC fiber. It is believed that by using silicon powder, the amount of excess silicon present after forming the β-SiC fiber is decreased. Since the only silicon present in the 1500 C zone is the silicon powder coated on the carbon fiber, less silicon is present in the 1500 C zone as compared to the molten silicon bath. Accordingly, after reacting to form the β-SiC fiber, it is believed that less silicon will be present and require removal.

Any silicon powder can be used in the methods of the disclosure to prepare a β-SiC fiber. For example, the silicon powder can have an average particle size of 400 nm to 500 nm, or any values there between or ranges defined by such values.

### Carbon Fiber Source

Any carbon fiber can be used in the methods of the disclosure to prepare a β-SiC fiber. For example, the carbon fiber can have an amorphous phase structure, a crystalline phase structure, or a combination thereof. For example, the carbon fiber can comprise an amorphous structure. For example, the carbon fiber can comprise a crystalline structure, i.e., the carbon fiber can comprise graphite. For example, the carbon fiber can include different types of crystalline phase. For example, the carbon fiber can be graphite.

It has been observed that the adhesion between the molten silicon bath and the carbon fiber is improved with the presence of the amorphous phase. It can be advantageous to utilize an amorphous carbon fiber or amorphous phase containing carbon fiber in the methods of the disclosure, for example, where faster rate of reaction is desired. It was observed, however, that crystalline carbon fiber or crystalline phase containing carbon fibers can be utilized in methods of the disclosure as well and successfully used for producing the β-SiC fiber.

The carbon fiber can have any desired diameter. The hold time can be selected depending in part on the carbon fiber diameter, with larger diameters generally requiring longer hold times. For example, the carbon fiber can have a diameter of about 5.0 μm to about 10 μm. For example, the diameter can be about 5.0, 5.5, 6.0, 6.5, 7.0, 7.5, 8.0, 8.5, 9.0, 9.5, or 10.0 μm, or any values there between or ranges defined by such values.

### β-SiC Fiber

The β-SiC fiber resulting from the methods of the disclosure can have a low oxygen content, a low carbon content, and/or be free of or substantially free of alpha silicon carbide (α-SiC) phase. β-SiC fibers of the disclosure can have high purity and rigid structural integrity.

For example, the β-Si fiber is free of oxygen. For example, the β-SiC fiber can be substantially free of oxygen. For example, the β-SiC fiber can have an oxygen content of about 0, 0.5, 1.0, 1.5, or 2%, or any values there between or ranges defined by such values.

For example, the β-SiC fiber can be substantially free of α-SiC phase or amorphous SiC. The β-Si fiber is expected to be free of α-SiC phase because only develops if the fiber is heated or exposed to a temperature above 1700° C. For example, the β-SiC fiber can have an α-SiC phase content of 0%. For example, the β-SiC fiber can have an amorphous SiC phase content of about 1, 1.5, 2, 2.5, 3, 3.5, 4, 4.5, or 5%, or any values there between or ranges defined by such values.

The β-SiC fiber of the disclosure can have a larger diameter than the carbon fiber before immersion in the molten silicon bath. For example, the β-SiC fiber can have a diameter of 10.0 μm to 20.0 μm, where the original carbon fiber had a diameter of 5 μm to 10 μm.

The β-SiC fiber can have a lower carbon content than the carbon fiber starting material. The β-SiC fiber is expected to have a lower carbon content since the β-SiC fiber includes SiC, while the carbon fiber only includes carbon. For example, the β-SiC fiber can have a carbon content of about 2, 2.5, 3, 3.5, 4, 4.5, or 5%, or any values there between or ranges defined by such values.

For example, in an embodiment, a carbon fiber having a diameter of 6.5 μm to 8.0 μm is immersed in a molten silicon bath and retained in the molten silicon bath for a hold time of 24 hours and at a temperature of 1460° C. and pressure of 1 atm.

### EXAMPLES

The following examples are provided for illustration and are not intended to limit the scope of the invention.

### Methods

Carbon fiber was obtained either in an amorphous form (Fiberglast), or a crystalline form (Zoltek). Si powder was obtained from commercial sources. The molten Si bath was housed in graphite and formed by exposing a graphite housing to react with Si at 1700° C. for 10 hours to develop SiC on the housing surface. Computational simulations were performed using the Vienna Ab initio Simulation Package (VASP), available at https://www.vasp.at/.

### Example 1—Method of Forming & Characterization of SiC Fiber

Pure silicon powder was heated to 1460° C. to form a molten silicon bath. The bath was held at 1460° C. Carbon fiber was then immersed in the molten silicon bath and retained for various periods of time and reaction between the carbon fiber and silicon molten bath was analyzed at each time period. The pressure during immersion and retention of the carbon fiber in the molten silicon bath was maintained between 0.9 to 1.1 atm, and the process was performed in an inert atmosphere.

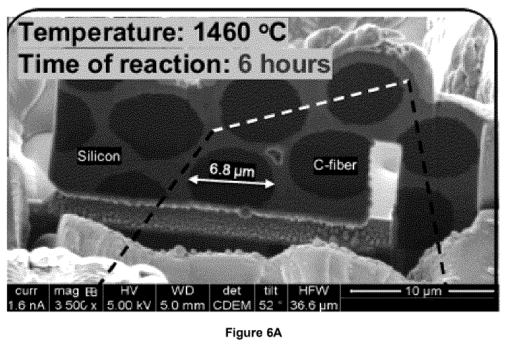

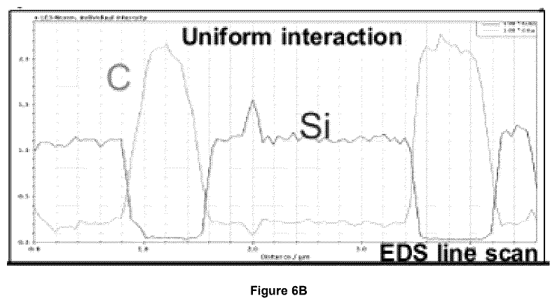

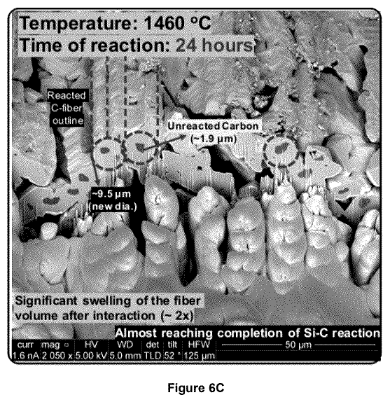

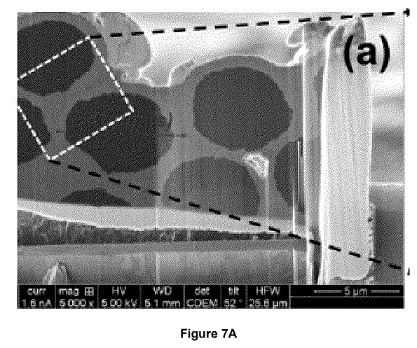

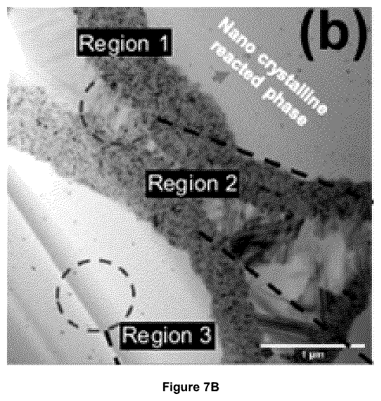

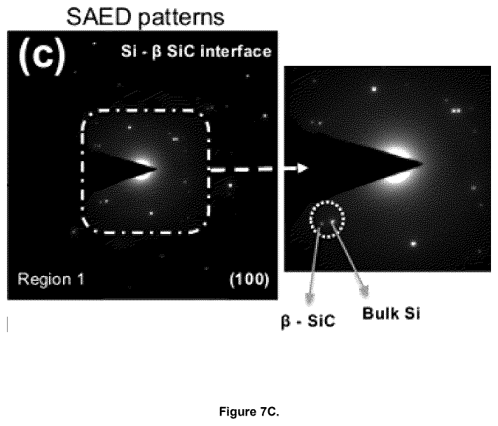

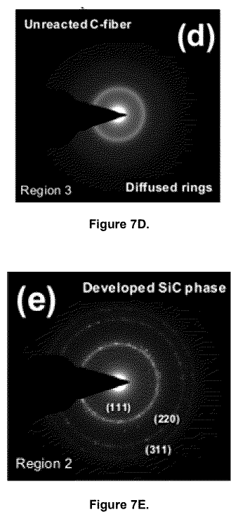

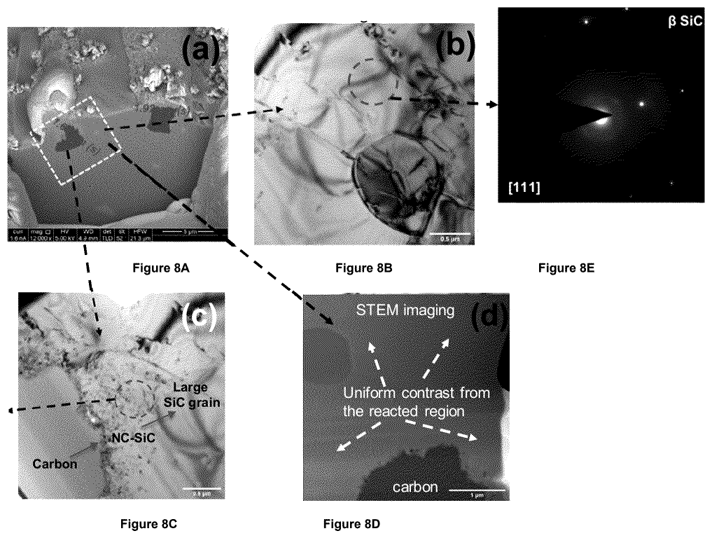

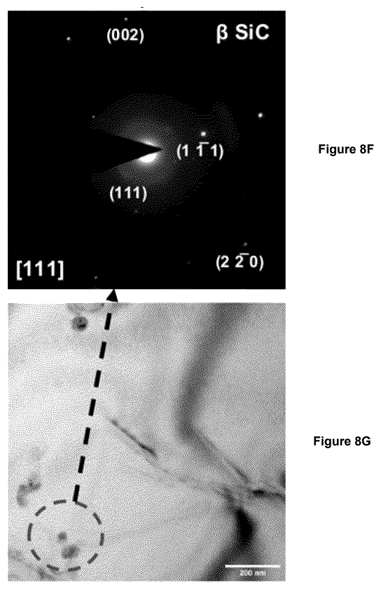

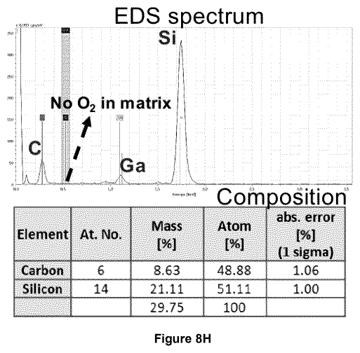

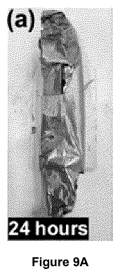

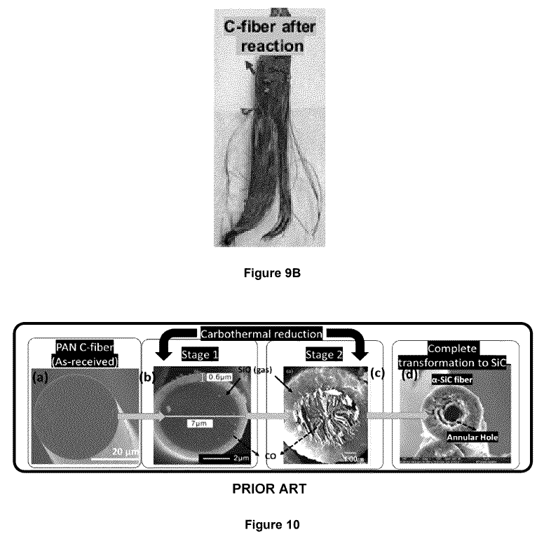

The silicon carbide fiber was isolated and characterized by scanning electron microscopy with energy-dispersive X-ray spectroscopy (SEM-EDS) to measure the chemical make-up of the recovered silicon carbide fiber. Referring to FIGS. 6A and 6B, SEM-EDS mapping of the fibers after 6 hours of immersion in the molten silicon bath showed uniform interaction of the silicon with the carbon fibers. Referring to FIG. 6C, after 24 hours of immersion, only a small portion of unreacted carbon remained, and significant swelling of the fiber was observed. Referring to FIGS. 7A and 7B, it was observed that after 6 hours of immersion in the molten silicon at 1460° C., about 500 nm of SiC formed around each fiber. Referring to FIGS. 7C-7E, after 6 hours of immersion in the molten silicon at 1460° C., the β-SiC phase was confirmed by SAED done in TEM. Referring to FIGS. 8A-8G, after 24 hours of immersion in the molten silicon bath, the resulting fiber has even less unreacted carbon and showed a transition from nanocrystalline grains of SiC to large SiC grains. Referring to FIG. 6H, EDS performed on the resulting fiber showed that no oxygen was present in the fiber matrix.

As the SiC formed, the unreacted carbon content of the fiber decreased as carbon from the fiber reacted with the silicon in the molten bath to form SiC. The recovered silicon carbide fiber contained less unreacted carbon than the SiC fiber synthesized with the Si vapors.

### Comparative Example 1—Synthesis with Non-Immersed Pure Si Powder

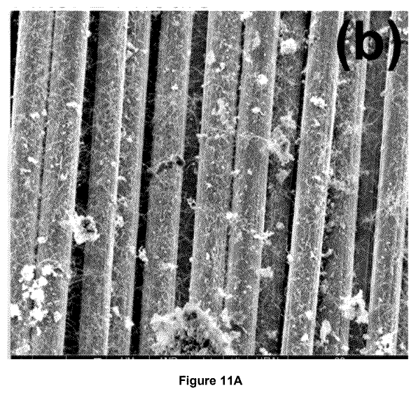

A SiC fiber was produced using a molten silicon bath, formed by heating pure silicon as described above to 1460°, but with the carbon fiber suspended above the molten silicon bath by 3 to 5 mm and held in suspension above the molten for 24 hours. Referring to FIG. 9A, the molten Si bath and suspended carbon fiber were wrapped and sealed in tantalum foil to retain the vaporized silicon from the molten bath as well as prevent the molten bath and carbon fiber from exposure to O₂ gas. Referring to FIG. 9B, SiC fibers formed over the 24 hours of reaction of Si vapors with the suspended carbon fiber.

However, SEM-EDS mapping of the fibers showed that some regions of unreacted carbon remained in the fibers after 24 hours of reaction. Since the carbon fiber was suspended above the molten Si bath, the Si vapors generated from the bath have to come into contact with the carbon fiber. Without being bound by theory, it is believed that the Si bath cannot generate a sufficiently high vapor pressure to completely react with the carbon fiber using this suspension method.

By contrast, the method of the disclosure allowed for a more uniform interaction of the molten silicon with the fiber and advantageously provides a method that does not depend upon the vapor pressure of the Si.

### Comparative Example 2—Conventional Syntheses of SiC Fiber

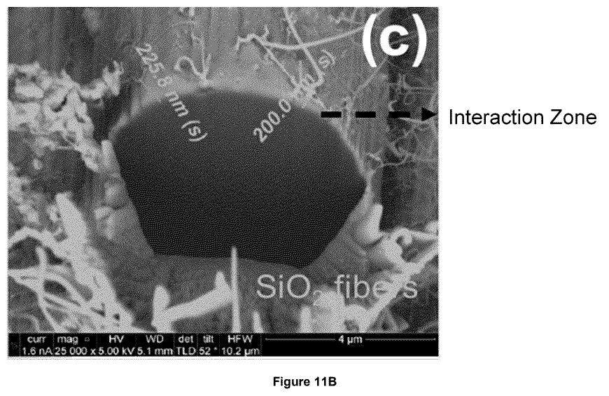

Referring to FIG. 10, SiC fiber was synthesized according to U.S. Pat. Nos. 9,272,913 and 8,940,391 and characterized for comparison with the β-SiC fiber produced in Example 1. In contrast to Example 1, the syntheses with either pure SiO₂ or mixtures of SiO₂ and Si powder require the silicon source to be vaporized to a silicon containing gas in order to interact with the carbon fiber.

Synthesis with Pure SiO₂

For comparison, silicon carbide fiber was synthesized using silicon containing gas, that used silica (SiO₂) as the source of Si. The carbon fiber was exposed to the silicon containing gas, to allow the Si vapors to directly interact with the carbon fiber. The SiO₂ was heated to 1450° C. and the fiber was reacted for 24 hours.

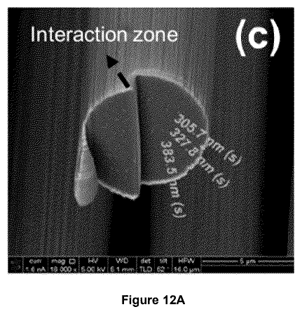

Referring to FIGS. 11A and 11B, SEM-EDS mapping of the fibers formed using SiO₂ as a silicon source showed the net thickness of the SiC layer formed was ˜200 nm after 24 hours of exposure, as compared to the ˜500 nm net thickness observed in Example 1.

At 1450° C., the vapor pressure of SiO₂ is not high enough to generate enough SiO₂ vapor to form silicon carbide in 24 hours. Thus, the interaction rate between the SiO₂ vapors and carbon fibers is insufficient for synthesizing β-SiC fiber.

Synthesis with Combination of SiO₂ and Si Powder

The synthesis of silicon carbide fiber was also evaluated using a silicon containing gas that used a mixture of silica (SiO₂) and Si powder as sources of Si. Similar to the procedures described above, the SiO₂/Si mixture was heated to 1450° C., the carbon fiber was exposed to the silicon containing gas and reacted for 24 hours.

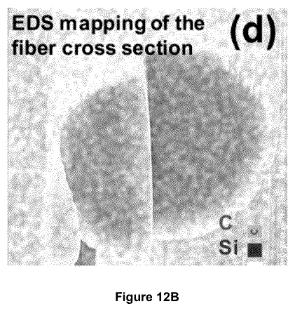

Referring to FIGS. 12A and 12B, SEM-EDS mapping of the silicon carbide fiber showed that the net thickness of the SiC layer formed is ˜300 nm after 24 hours of exposure to SiO₂/Si. While the net thickness of the SiC formed using SiO₂/Si was greater than for SiO₂ alone, the layer of SiC formed was lower than the net thickness of the SiC formed when a molten Si bath was used. Thus, at 1450° C., the interaction rate between the SiO₂ & Si vapors and carbon fiber is insufficient for synthesizing β-SiC fiber.

In contrast to the methods of the disclosure, the process of producing the SiC fiber with SiO₂ alone was not observed to be an effective approach at temperatures<1500° C. Similarly, while the SiO₂/Si mixture was slightly better than SiO₂ alone, the reaction rate was slow and found to be highly dependent on the ability to maintain the vapor pressure of the silicon containing gas around the carbon fiber.

### Example 2—Computer Simulations

The effect of the carbon fiber source on preparing β-SiC fiber was further investigated with computational analyses. Specifically, computer simulations were analyzed to evaluate the adhesive forces between the molten Si phase (Siₘₑₗₜ) and the carbon fiber (C_{graphite} or Cₐₘₒᵣₚₕₒᵤₛ), and the enthalpy of formation of SiC phases at different temperatures.

### Study on Adhesion Between Si Melt and Carbon Fiber

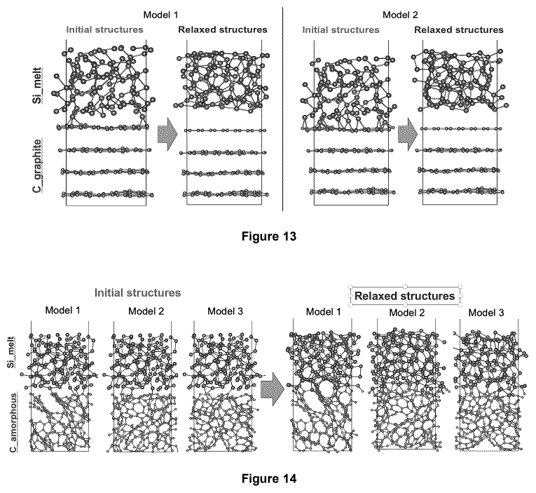

The adhesion strength of Si melt on carbon fiber surface was simulated using DFT calculations for both crystalline and amorphous carbon surfaces. FIGS. 13 and 14 are schematic illustrations showing the atomic structures of the Siₘₑₗₜ/C_{graphite} and Siₘₑₗₜ/Cₐₘₒᵣₚₕₒᵤₛ interfaces before and after structural relaxations, in which the atomic structures of Si melt and amorphous carbon were generated using ab initio molecular dynamics (AIMD) simulations. The adhesion strength of Siₘₑₗₜ on the carbon surface can be quantified by the work of adhesion for the interface. Table 1 summarizes the work of adhesion for Siₘₑₗₜ/C_{graphite} and Siₘₑₗₜ/Cₐₘₒᵣₚₕₒᵤₛ interfaces calculated by DFT.

TABLE 1
DFT calculated work of adhesion of Si
melt and carbon fiber interfaces.

| Interface | Work of adhesion (J/m²) |
|---|---|
| Siₘₑₗₜ/C_{graphite} | 0.009 ± 0.003 |
| Siₘₑₗₜ/Cₐₘₒᵣₚₕₒᵤₛ | 3.464 ± 0.682 |

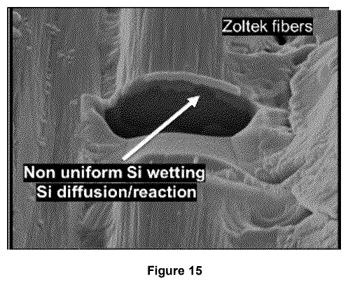

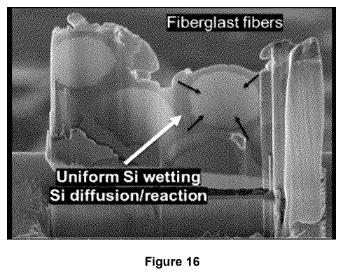

Si melt has very weak adhesion on crystalline carbon surface, therefore low wettability on graphite surface as shown in FIGS. 15 and 16. By comparison, the adhesion of Si melt on an amorphous carbon surface is much stronger, therefore high wettability of Si. For this reason, amorphous carbon phase is believed to be beneficial to the adhesion of Si melt on the carbon fiber surface, thus also beneficial to the formation of SiC phase.

### Study of Enthalpy of Formation of SiC Phases

To study the feasibility of the formation of beta SiC phase from Si melt and carbon fiber, DFT simulations were performed to predict the enthalpy of formation of various SiC phases from different sources of carbon phases, i.e., crystalline, and amorphous phases. Table 2 summarizes the enthalpy of formations for alpha, beta and amorphous SiC phases from Si melt and crystalline or amorphous carbon phase at 1460° C.

TABLE 2
Enthalpy of formation of various SiC phases
at 1460° C. predicted by DFT calculations.

| Reaction | Siₘₑₗₜ | Carbon | SiC | ΔH_{f} (eV) |
|---|---|---|---|---|
| Siₘₑₗₜ + C_{graphite} → SiC_{α} | −4.81 | −8.95 | −14.33 | −0.57 |
| Siₘₑₗₜ + C_{graphite} → SiC_{β} | −4.81 | −8.95 | −14.46 | −0.71 |
| Siₘₑₗₜ + C_{graphite} → SiCₐₘₒᵣₚₕₒᵤₛ | −4.81 | −8.95 | −13.09 | 0.66 |
| Siₘₑₗₜ + Cₐₘₒᵣₚₕₒᵤₛ → SiC_{α} | −4.81 | −8.30 | −14.33 | −1.21 |
| Siₘₑₗₜ + Cₐₘₒᵣₚₕₒᵤₛ → SiC_{β} | −4.81 | −8.30 | −14.46 | −1.35 |
| Siₘₑₗₜ + Cₐₘₒᵣₚₕₒᵤₛ → SiCₐₘₒᵣₚₕₒᵤₛ | −4.81 | −8.30 | −13.09 | 0.02 |

Due to lower energy of amorphous phase of carbon, lower enthalpy of formation for SiC phases is expected for amorphous carbon phase compared to the crystalline carbon phase. Therefore, amorphous carbon is the preferred phase for carbon fiber in order to form SiC phase. At 1460° C., beta SiC has the lowest enthalpy of formation compared to the other two SiC phases, i.e., alpha, and amorphous phases. Beta SiC is expected to be the dominant structure of SiC when Si melt is reacted with either crystalline or amorphous carbon phase in carbon fiber.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A method of preparing beta silicon carbide (β-SiC) fiber, comprising:
immersing a carbon fiber in a molten silicon bath at a temperature of up to 1650° C. and a pressure of 0.9 to 1.1 atm in an inert atmosphere and retaining the carbon fiber in the molten silicon bath for a hold time to react the carbon fiber with silicon present in the molten silicon bath and produce β-SiC fiber.

2. The method of claim 1, wherein the molten silicon bath is formed by heating elemental silicon powder under an inert gas to a temperature of 1400° C. to 1650° C.

3. The method of claim 1, wherein the carbon fiber has a diameter of about 5.0 μm to about 10.0 μm.

4. The method of claim 1, wherein the carbon fiber comprises an amorphous phase.

5. The method of claim 1, wherein the carbon fiber comprises a crystalline phase.

6. The method of claim 1, further comprising removing unreacted silicon from the β-SiC fiber after the hold time.

7. The method of claim 1, wherein the hold time is about 12 hours to about 48 hours.

8. The method of claim 1, wherein immersing and retaining the carbon fiber in the molten silicon bath comprises drawing the carbon fiber through the molten silicon bath at a draw rate that results in each immersed portion of the carbon fiber to be retained in the molten silicon bath for the hold time.

9. The method of claim 8 further comprising drawing the carbon fiber through an opening in a graphite structure after the carbon fiber is drawn through the molten silicon bath to remove excess silicon.

10. The method of claim 1, wherein the β-SiC fiber has an O₂ content of 0% to 2%.

11. The method of claim 1, wherein the β-SiC fiber has a diameter of 10.0 μm to 20 μm.

12. The method of claim 1, wherein the β-SiC fiber has a carbon content of 2% to 5%.

13. The method of claim 1, wherein the β-SiC fiber is free of alpha silicon carbide (α-SiC) phase.

14. The method of claim 1, wherein the method does not produce CO emissions.

15. The method of claim 1, wherein the temperature is 1450° C. to 1650° C.

16. The method of claim 1, wherein:
the carbon fiber has a diameter of 6.5 μm to 8.0 μm; and
reacting the carbon fiber and the silicon source comprises:
reacting for 24 hours;
reacting at a temperature of 1460° C.; and
reacting at a pressure of 1 atm; or
wherein:
the carbon fiber comprises an amorphous phase;
the β-SiC fiber a carbon content of 0.1% to 0.5%; and
reacting the carbon fiber and the silicon source comprises:
reacting for 24 hours;
reacting at a temperature of 1460° C.; and
reacting at a pressure of 1 atm.

17. A method of preparing beta silicon carbide (β-SiC) fiber, comprising:
immersing a carbon fiber in silicon powder at a temperature of 650° C. to 800° C. to thereby coat the carbon fiber with the silicon powder; and
transferring the coated carbon fiber to a heating zone and heating the silicon powder coated carbon fiber to a temperature of 1400° C. up to 1650° C. to react the carbon fiber with the silicon powder to form a β-SiC fiber.

18. The method of claim 17, wherein the carbon fiber and the silicon powder are heated for 12 hours to about 48 hours.

19. The method of claim 17, wherein:
the carbon fiber has a diameter of 6.5 μm to 8.0 μm;
immersing the carbon fiber is at a temperature of 700° C.; and
reacting the carbon fiber and the silicon powder comprises:
reacting at a temperature of 1460° C.; and
reacting for 24 hours.

20. The method of claim 17, wherein the silicon powder has an average particle size of about 400 nm to about 500 nm.
